(19) United States
(12) Patent Application Publication
(10) Pub. No.: US 2013/0094744 A1
(43) Pub. Date: Apr. 18, 2013

(54) IMAGE PROCESSING DEVICE

(71) Applicants: Hiroshi Sawada, Otsu City (JP); Michel Dargis, Lorraine (CA)

(72) Inventors: Hiroshi Sawada, Otsu City (JP); Michel Dargis, Lorraine (CA)

(73) Assignee: Shimadzu Corporation, Kyoto (JP)

(21) Appl. No.: 13/272,346

(22) Filed: Oct. 13, 2011

(51) Int. Cl. G06K 9/00

(52) U.S. Cl. 382/132

(57) ABSTRACT

The provision of a feature extracting portion for obtaining sequentially images captured by an x-ray imaging device and for extracting features relating to the densities of the images; an image classifying portion for dividing the images into groups based on the features extracted by the feature extracting portion; a memory portion for storing the images, which have been divided into groups by the image classifying portion, together with imaging time stamps for each group; an image data processing portion for processing, for each group, images stored in the memory portion; and a monitor for outputting images processed by the image data processing portion.

### CROSS REFERENCE TO RELATED APPLICATION

This application is based on Japanese Patent Application No. 2009-120989 filed May 19, 2009, which is incorporated herein by reference. This application was published Dec. 2, 2010 as JP 2010-268846.

### FIELD OF TECHNOLOGY

The present invention relates to an image processing device for processing an image captured through an x-ray imaging device, and, in particular, through a digital transparent imaging device (DF (digital fluorography) device).

### BACKGROUND

Recently x-ray devices provided with fluorography functions have come to be used in diagnosis and treatment. When x-ray imaging devices are operated in the fluorographic mode, x-rays are emitted continuously at the examination subject, where the x-rays that pass through the examination subject are converted into optical images by image intensifying tubes (I. I.), and these optical images are captured by a video camera. The video signals that are captured by the video camera are converted into digital graphic data for each frame by an A/D converter, and are inputted into a recursive filter.

The recursive filter reduces noise through cancellation by weighting and summing a frame image obtained at the current point in time and an image of a frame obtained in the past. Because of this, when movement occurs in the examination subject during the imaging, the part wherein there is movement in the image, processed through this weighting summing process, will produce blurring in the diagnostic images, which becomes an impediment to diagnostics.

Because of this, a method has been proposed wherein weighting factors for the recursive filtering are set by detecting the period of bodily motion in the examination subject by measuring electrocardio signals and respiration signals produced by the examination subject and synchronizing to that period (See, for example, Japanese Unexamined Patent Application Publication 2007-330522). However, in this method it is not easy to detect the period of bodily motion in the examination subject nor to change, for example, the weighting factors synchronized to the period of bodily motion, and thus there is a problem in that crisp examination images cannot be obtained easily.

Moreover, in the digital subtraction angiography (DSA) imaging method, first an average of the image data is calculated for eliminating the noise component for images of a plurality of frames imaged prior to the injection of a radio-opaque substance into the examination subject. The averaged image is stored in memory as a mask image. Moreover, for each individual frame of the image, a subtraction process is performed between the live image at that time and the mask image, to produce the diagnostic images sequentially for images of the examination subject (known as “live images”), captured sequentially after the injection of the radio-opaque substance into the examination subject.

In the subtraction processing, while the image parts that have no change in position or density as time elapses will be eliminated, on the other hand, image parts produced through changes in position or density will remain. Consequently, it is possible to extract only the blood vessels wherein before and after changes in density are produced through the injection of the radio-opaque substance, insofar as there is no bodily motion of the examination subject between capturing images, thereby making it easy to reveal pathologies such as vascular narrowing.

However, because bodily motion is always produced in an examination subject through respiration, pulse, and the like, depending on the position being imaged, a shift will be produced in the target position other than blood vessels, such as in bones and internal organs, between the images to be subjected to the subtraction process, leaving artifacts in the image after the subtraction problem, producing a problem in that the diagnostic imaging will not be crisp.

In order to solve this problem, methods have been proposed, for example, wherein the most appropriate single frame image is selected from a plurality of frame images captured prior to the injection of the radio-opaque substance into the examination subject, for use as the mask image (See, for example, Japanese Unexamined Patent Application Publication 2004-112469 and Japanese Unexamined Patent Application Publication 2006-87631). However, in this method the mask image is structured from only a single frame image, and thus no noise reduction process such as averaging or the like can be performed, and thus the subtraction process is performed using a mask image that includes the noise component.

Consequently, the object of the present invention is to provide an image processing device able to produce a crisp diagnostic image easily, without being afThcted by bodily motion due to respiration or pulse, or the like, of the subject being imaged.

### SUMMARY OF THE INVENTION

In order to solve the problems set forth above, the present example structures an image processing device having a feature extracting portion for obtaining sequentially images captured by an x-ray imaging device and for extracting features relating to the densities of the images; an image classifying portion for dividing the images into groups based on the features extracted by the feature extracting portion; a memory portion for storing the images, which have been divided into groups by the image classifying portion, together with imaging time stamps for each group; an image data processing portion for processing, for each group, images stored in the memory portion; and a monitor for outputting images processed by the image data processing portion.

In this structure, preferably the feature extracting portion calculates a position of a centroid of an image, with the density of the image as the weighting, and, with the amount of movement of the centroid from a position that has been determined in advance as a feature of the image, divides the images into groups based on the amount of movement of the centroid, or the feature extracting portion calculates a variance in the density of an image, as a feature of the image, and divides the images into groups based on the variance.

Moreover, preferably the structure is such that the x-ray imaging device performs imaging before and after injection of a radio-opaque substance into an examination subject, where images taken before and after injection with the radio-opaque substance are stored, for each group, together with an imaging time stamp, where the data processing portion not only produces a mask image through averaging the images prior to the injection of the radio-opaque substance, but also performs a subtraction process of the mask image, in the sequence of the imaging time stamps, on each individual image after injection of the radio-opaque substance.

Furthermore, preferably the structure is such that the image data processing portion performs a recursive filtering process for each image within the same group, wherein the image and at least the immediately previous image are weighted and added in the sequence of the imaging time stamps.

Furthermore, preferably the data processing portion performs an imaging process on each group in accordance with features of the group, and performs an imaging process across the groups on images after image processing.

Given the present example, the images captured through an x-ray imaging device are divided into groups based on features pertaining to the density and image processing is performed on individual groups, and thus when bodily motion occurs between images, the image before the examination subject moved and the image after the movement are divided into separate groups, and each is processed separately. In this way, images wherein the features are quite similar to each other are subjected to image processing, so that essentially no artifacts occur in the images after processing. The result is that even if bodily motion occurs between images it is still possible to obtain crisp diagnostic images. Because, in the present example, the images that are captured by an x-ray capturing device are divided into groups and image processing is performed depending on the features of the groups, for each individual group, and image processing is performed across groups on the images after this image processing, it is possible to perform image calculations after minimizing the effects of bodily motion, and the like.

### BRIEF DESCRIPTION OF THE DRAWINGS

FIG. 1 is a block diagram illustrating a schematic structure of an image processing device according to an example.

FIG. 2 is a flowchart for explaining the operation of the image processing device.

### DETAILED DESCRIPTION OF THE INVENTION

An example of the present invention is explained below in reference to the appended drawings. In the example, the image processing device is applied to an x-ray imaging device that performs imaging before and after the injection of a radio-opaque substance into the examination subject, but the image processing device can also be applied to, for example, MRI, PET, SPECT, and ultrasonic examination devices rather than x-ray imaging devices.

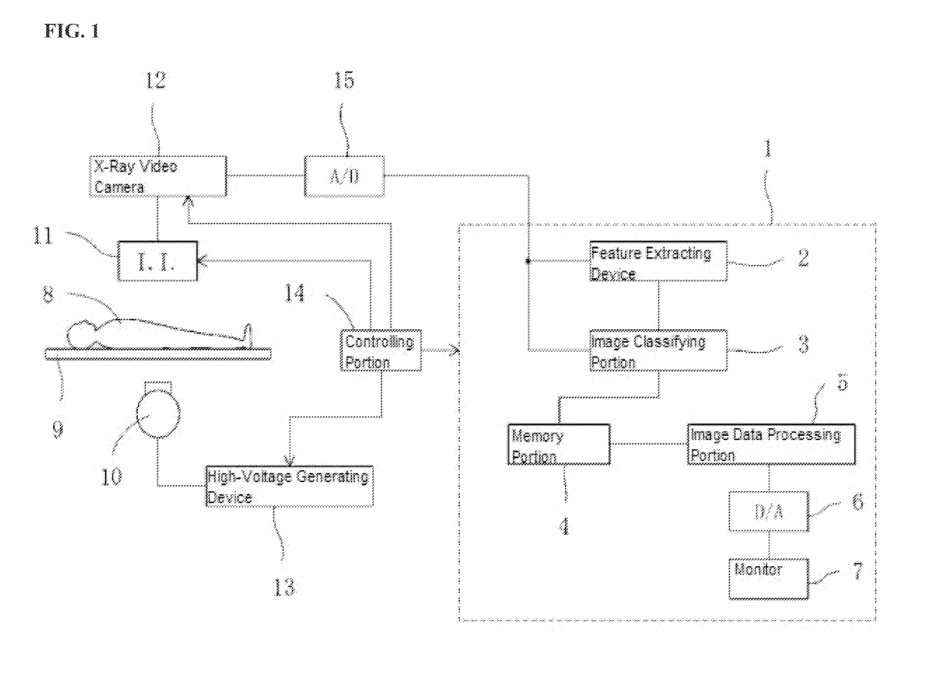

Referencing FIG. 1, the x-ray imaging device is provided with: an examination table 9 upon which the examination subject 8 is placed, an x-ray tube 10 for emitting x-ray's towards the examination subject 8, and an x-ray detecting device for detecting transmitted x-rays from the examination subject 8. The x-ray detecting devices structured from an I. I. (x-ray fluorescent intensifying tube) 11 and an x-ray video camera 12 in the present example of embodiment, but instead an FPD (flat panel-type x-ray detecting device) can be used as the x-ray detecting device. The x-ray tube 10 and the I. I. 11 are arranged facing each other with the examination table 9 interposed therebetween, and are supported by supporting portions (not shown). The x-ray tube 10 is connected to a high-voltage generating device 13, and receives a supply of a tube voltage and a tube current therefrom.

An analog signal that is outputted from the x-ray video camera 12 is inputted into an A/D converting device 15. The A/D converting device 15 converts the inputted analog signal into a digital signal, and, for each frame, outputs image data to the image processing device 1 according to the present invention.

The high-voltage generating device 13, the I. I. 11, and the x-ray video camera 12, along with the image processing device 1, are controlled by a controlling portion 14.

In this way, x-rays are emitted toward the examination subject 8 from the x-ray tube 10 with an appropriate timing before and after the injection of the radio-opaque substance into the examination subject 8, to image the target position of the examination subject 8 at that time, and the captured images are sequentially read into the image processing device 1.

The image processing device 1 has a feature extracting portion 2 for capturing images sequence late and extracting features related to the densities of the images; and image classifying portion 3 for dividing images into groups based on the features extracted by the feature extracting portion 2; and a memory portion 4 for storing the image data that has been divided into groups by the image classifying portion 3, together with imaging time stamps for each group.

The feature extracting portion 2 calculates, for example, the positions of the centroids of the image, weighted by the density of the image, and, with the amounts of movement of the centroids from a position determined in advance as the features of the images, divides the images into groups based on the amounts of movement of the centroids. Conversely, the image extracting portion 2 calculates the variances in the images, as the features of the images, and divides the images into groups based on the variances.

The method of extracting features relating to the densities of the images is not limited to the methods described above, hut rather can use any known method of extracting features used in normal digital image processing. In this case, combining together the density information for all of the pixels that structure the image for the frame and then performing the feature extracting process based on this combined information cannot be performed at high speed, and thus, for example, preferably an image for one frame can be partitioned into a plurality of image parts that each include a number of pixels that is determined in advance, where the maximum density value in each of the image parts are gathered together and the image extraction process is performed based on that information, or when the position that is being imaged is specified in advance, reference density information obtained through predictions pertaining that portion can be considered in advance to perform the feature extraction process.

Additionally, preferably grouping is performed by images captured with the same timing as the period of respiration and pulse being grouped into respectively identical groups, in consideration of the movement of each position accompanying the periodicity of respiration and pulse of the examination subject.

The image processing device 1 is also provided with an image data processing portion 5 for processing, for each group, the images that are stored in the memory 4. In the present example of embodiment, the image data processing portion 5 not only produces mask images by averaging the images, within identical groups, before the injection of the radio-opaque substance, but also performs a subtraction process with the mask image in the sequence of the imaging time stamps for each of the images after the injection of the radio-opaque substance.

The image processing device 1 further comprises a D/A converting device 6 for converting into an analog signal the digital signal that is outputted from the image data processing portion 5, and a monitor 7 for displaying the image for which the subtraction process has been performed, based on the signal from the D/A converting device 6.

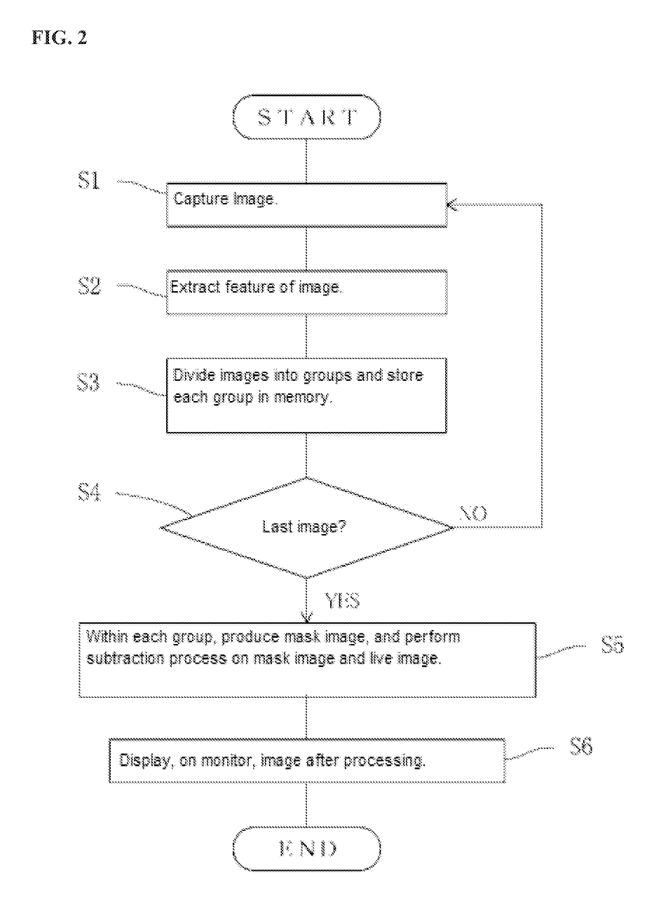

FIG. 2 is a flowchart for explaining the processing operations by the image processing device of FIG. 1. Referencing FIG. 2, the image processing device, each time an image is captured by the x-ray imaging device (S1 in FIG. 2), extracts the feature of that image (S2 in FIG. 2), and separates the images into groups based on the extracted features, and then, for each group, stores in memory the image data that has been divided into groups, together with the imaging time stamps thereof (S3 in FIG. 2). When the grouping is completed for the last image that is captured (S4 in FIG. 2), the image processing device not only produces mask images through averaging the images, within the individual groups, from before the injection of the radio-opaque substance, but also performs the subtraction process, with the mask images, on each individual image after the injection of the radio-opaque substance (on each individual live image), in sequence of the imaging time stamps (S5 in FIG. 2), and then displays on the monitor of the images after the processing (S6 in FIG. 2).

In this way, in the image processing device according to the present invention, images captured from before and after the injection of the radio-opaque substance into the examination subject are grouped based on features relating to the densities thereof, in the image data within each group are averaged, and the images thus obtained are used as mask images. Consequently, mask images are produced wherein the noise is reduced and essentially no artifacts are visible. Furthermore, because a subtraction process is performed between the live images that are captured after the injection of the radio-opaque substance into the examination subject and the mask image, within each group, crisp diagnostic images are obtained easily wherein essentially no artifacts are produced within the diagnostic images, even if bodily motion occurs between images.

The structure of the image processing device according to the example is not limited. In another example, the x-ray imaging device performs imaging regardless of whether or not the radio-opaque substance has been injected into the examination subject, where the image processing device sequentially reads in the images captured by the x-ray imaging device. In this example, all of the structures are identical to those in the example described above, with the exception of the image data processing portion. That is, the image data processing portion is structured so as to perform a recursive filtering process instead of performing the subtraction process such as in the case in the example described above.

The image data processing portion, upon completion of the grouping of the last image that is obtained, performs weighted summation of the current image and at least the immediately preceding image, in the order of the imaging time stamps, for each of the images within a single group, and displays on the monitor the images after the summing processes.

Because, in the present example, images that are captured sequentially by an x-ray imaging device are divided into groups in accordance with features relating to density and a recursive filtering process is performed within identical groups, images having very similar features are subjected to the filtering process together. Consequently, crisp diagnostic images wherein essentially no artifacts are produced can be obtained even when bodily motion of the examination subject occurs between images.

1. An image processing device comprising:
a feature extracting portion obtaining images sequentially captured by an x-ray imaging device and extracting features relating to the densities of the images;
an image classifying portion dividing the images into groups based on the features extracted by the feature extracting portion;
a memory portion storing the images, which have been divided into groups by the image classifying portion, together with imaging time stamps for each group;
an image data processing portion processing, for each group, images stored in the memory portion; and
a monitor outputting images processed by the image data processing portion.

2. The image processing device as set forth in claim 1, wherein:
the feature extracting portion calculates a position of a centroid of an image, with the density of the image as the weighting, and, with the amount of movement of the centroid from a position that has been determined in advance as a feature of the image, divides the images into groups based on the amount of movement of the centroid.

3. The image processing device as set forth in claim 1, wherein:
the feature extracting portion calculates a variance in the density of an image, as a feature of the image, and divides the images into groups based on the variance.

4. The image processing device as set forth in claim 1, wherein:
the x-ray imaging device performs imaging before and after injection of a radio-opaque substance into an examination subject, where images taken before and after injection with the radio-opaque substance are stored, for each group, together with an imaging time stamp, where the data processing portion not only produces a mask image through averaging the images prior to the injection of the radio-opaque substance, but also performs a subtraction process of the mask image, in the sequence of the imaging time stamps, on each individual image after injection of the radio-opaque substance.

5. The image processing device as set forth in claim 1, wherein:
the image data processing portion performs a recursive filtering process for each image within the same group, wherein the image and at least the immediately previous image are weighted and added in the sequence of the imaging time stamps.

6. The image processing device as set forth in claim 1, wherein:
the data processing portion performs an imaging process on each group in accordance with features of the group, and performs an imaging process across the groups on images after image processing.
